(19) United States
(12) Patent Application Publication
(10) Pub. No.: US 2021/0292939 A1
(43) Pub. Date: Sep. 23, 2021

(54) THREE-DIMENSIONAL FABRIC AND SEWING METHOD THEREOF

(71) Applicant: TEX TILE ENTERPRISE CO., LTD., TAOYUAN CITY (TW)

(72) Inventor: KUO-PENG HUANG, New Taipei City (TW)

(21) Appl. No.: 16/824,864

(22) Filed: Mar. 20, 2020

(51) Int. Cl. D03D 25/00; B29C 70/24

(52) U.S. Cl. CPC D03D 25/005; B29C 70/24

(57) ABSTRACT

A three-dimensional fabric and a sewing method of making the same are provided. The method includes: providing a first three-dimensional fabric and a second three-dimensional fabric, placing the first fluffy flexible thread between the first inner side of the first three-dimensional fabric and the second inner side of the second three-dimensional fabric, and then stitching the first three-dimensional fabric and the second three-dimensional fabric to form a stitched structure with the first fluffy flexible thread being embedded therein.

### FIELD OF THE DISCLOSURE

The present disclosure relates to a three-dimensional fabric and a sewing method, and more particularly to a method for sewing the three-dimensional fabric and clothing structure by the method.

### BACKGROUND OF THE DISCLOSURE

In conventional fabric product materials, for example, foams or needle-punched fiber are generally used as the fabric materials of female bras. However, the products of foam material are stuffy, not breathable, and easily discolored, and the manufacture process also causes pollution concerns. On the other hand, the needle-punched fiber fabric products may suffer from fiber loss after washing, which causes the product to be deformed and the product life to be reduced.

A three-dimensional fabric is a three-layer fabric including support yarns that are sandwiched between two surface layers and that support the two surface layers, thereby stiffening the fabric. However, the conventional splicing and sewing methods may cause support yarns to be exposed, which seriously irritate the skin, thereby reducing comfort. In view of this, the conventional sewing method is not preferred in sewing of the three-dimensional fabrics. For example, bras are mostly molded by a compression molding method, but the compression molding method wastes a substantial amount of fabric material, causing a significant increase in cost, and is unable to avoid the disadvantages of the support yarns being exposed. Accordingly, the three-dimensional fabric could not be effectively popularized.

For the above-mentioned reasons, the present disclosure provides a three-dimensional fabric and a sewing method, thereby saving resources, reducing costs, and improving the comfort of the three-dimensional fabric products such as clothes and mattresses.

### SUMMARY OF THE DISCLOSURE

In response to the above-referenced technical inadequacies, the present disclosure provides a method of sewing a three-dimensional fabric and a three-dimensional fabric structure.

In one aspect, the present disclosure provides a method of sewing three-dimensional fabric including: providing a first three-dimensional fabric and a second three-dimensional fabric, the first three-dimensional fabric having a first inner side, and the second three-dimensional fabric having a second inner side; placing a first fluffy flexible thread between the first inner side and the second inner side; and stitching the first inner side and the second inner side to form a stitched structure enveloping the first fluffy flexible thread. A diameter of the first fluffy flexible thread is 0.2 cm more than a thickness of the first three-dimensional fabric or the second three-dimensional fabric.

Therefore, through the technical features of “the first fluffy flexible thread and the three-dimensional fabric” and “a diameter of the first fluffy flexible thread is 0.2 cm more than a thickness of the first three-dimensional fabric or the second three-dimensional fabric”, the present disclosure overcomes the disadvantages of the support yarns being exposed, and solves a problem on the stitched surface being uneven or being formed with protrusions after sewing, which maintains the skin-friendliness and comfort of the product. Moreover, the present disclosure can effectively omit a seam stripe on a seam or an edge, so as to avoid increasing a thickness of the fabric structure, and further provides the advantage of smoothness and being without any visible seams, making them nearly invisible under tight fitting clothing

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1A is a flowchart of a method of sewing a three-dimensional fabric according to a first embodiment of the present disclosure.

FIG. 1B is a flowchart of a method of sewing the three-dimensional fabric according to another embodiment of the present disclosure.

FIG. 2A is a schematic view of step S102 to S104 the method of sewing three-dimensional fabrics according to first embodiment of the present disclosure.

FIG. 2B is a schematic view of a product after the method of sewing the three-dimensional fabric according to first embodiment of the present disclosure.

FIG. 3A is a schematic view of a bra cup structure of one embodiment of the present disclosure.

FIG. 3B is a schematic view of a bra cup structure of another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The purpose of the present disclosure is to provide a method of sewing a three-dimensional fabric. The three-dimensional fabric is a multiple-layered fabric, including a top layer, a bottom layer and at least one support yarns connecting the top layer and the bottom layer, in which the support yarns can be selected from monofilament support yarns or multifilament support yarns. The three-dimensional fabric has a higher hardness by the support yarns between the top layer and bottom layer. However, when sewing the three-dimensional fabrics, the sewing pressure causes an uneven tilting direction of the support yarns, such that the product will be unbalanced after sewing and does not meet requirements. In addition, when sewing, the support yarns would puncture out of the top layer and/or bottom layer.

The method of sewing the three-dimensional fabric of the present disclosure is more particularly described in the following first embodiment and second embodiment, the sewing method of the present disclosure can be applied in sewing any three-dimensional fabric products, but not limited to a single product. However, in order to further describe the present disclosure, the second embodiment is used to describe a possible sewing product, a bra cup structure.

### First Embodiment

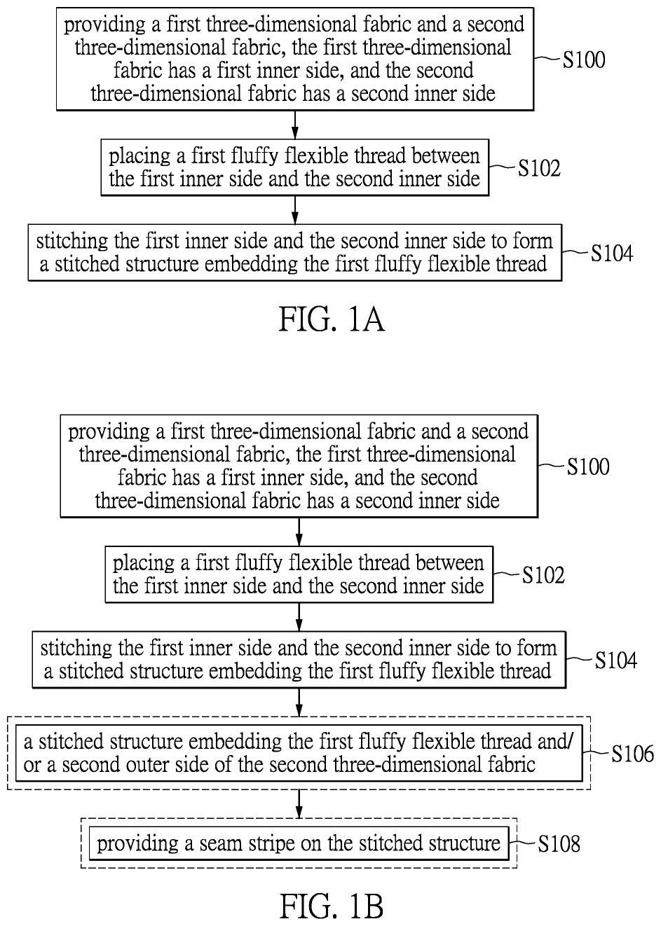

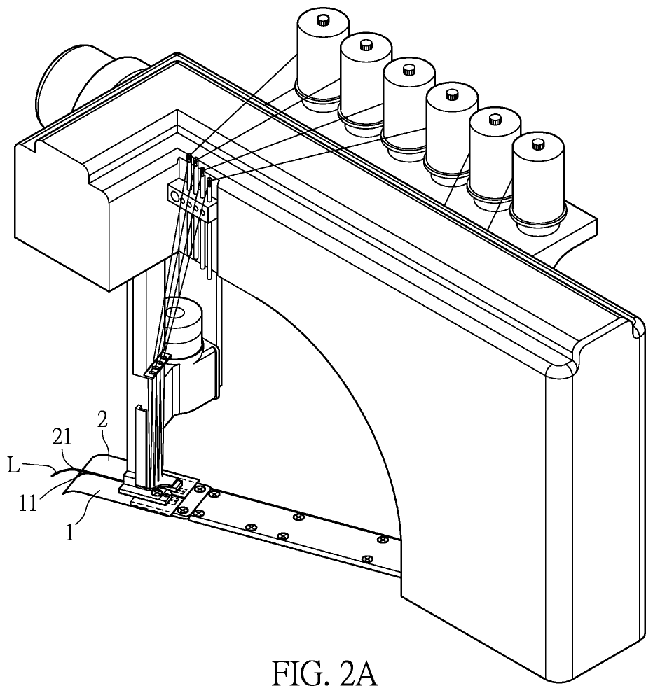

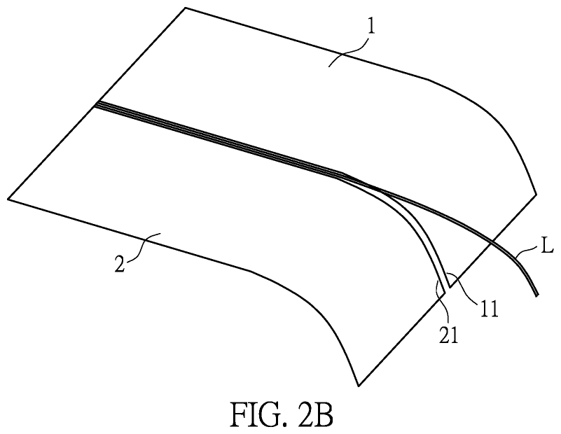

Referring to FIG. 1A-FIG. 1B and FIG. 2A-FIG. 2B, an embodiment of the present disclosure provides a method of sewing three-dimensional fabrics, including S100: providing a first three-dimensional fabric and a second three-dimensional fabric, the first three-dimensional fabric having a first inner side, and the second three-dimensional fabric having a second inner side; S102: placing a first fluffy flexible thread between the first inner side and the second inner side; and S104: stitching the first inner side and the second inner side to form a stitched structure enveloping the first fluffy flexible thread.

In addition, referring to FIG. 1B, optionally, the method of sewing three-dimensional fabrics of this embodiment further includes S106: binding a first outer side of the first three-dimensional fabric and/or a second outer side of the second three-dimensional fabric. Moreover, the binding step of S106 is providing a second fluffy flexible thread on a first outer side of the first three-dimensional fabric and/or a second outer side of the second three-dimensional fabric, and covering the second fluffy flexible thread with a binding tape; and stitching the binding tape, and forming a binding structure enveloping the second fluffy flexible thread on the first outer side and/or the second outer side.

Optionally, the method of sewing three-dimensional fabrics of this embodiment further includes S108: providing a seam stripe on the stitched structure, and a thickness of the seam stripe is between 0.2 and 0.3 cm.

In more detail, as shown in FIG. 2A to 2B, which is a schematic view of step S102 to S104 of the present disclosure and a schematic view of a product after the method of sewing three-dimensional fabrics. In this embodiment, the three-dimensional fabric after sewing includes a first three-dimensional fabric 1 and a second three-dimensional fabric 2, the first three-dimensional fabric 1 has a first inner side 11 and the second three-dimensional fabric 2 has a second inner side 21, the first inner side 11 is spliced to the second inner side 21, and a first fluffy flexible thread L is disposed between the first inner side 11 and the second inner side 21, such that the first three-dimensional fabric 1 and the second three-dimensional fabric 2 can be stitched together with a sewing machine. Further, optionally, a seam stripe is disposed on the stitching structure (not shown in the figure).

Preferably, a stitch length of the first inner side of first three-dimensional fabric and the second inner side of the second three-dimensional fabric is between 16 and 20 stitches/inch. If the stitch length is less than 16 stitches/inch, the support yarns of the three-dimensional fabric would protrude from the surface, irritate the skin. If the stitch length is more than 20 stitches/inch, the stitched structure of the three-dimensional fabric will be uneven.

Preferably, the first fluffy flexible thread can be wool, and the diameter of the first fluffy flexible thread is 0.2 cm more than the thickness of the first three-dimensional fabric or the second three-dimensional fabric. Thereby, the first fluffy flexible thread can provide a space to accommodate the support yarns which protrudes from the three-dimensional fabric due to the pressure of sewing. In other words, fibers in the three-dimensional fabrics are bent or inserted into the gap of the first fluffy flexible thread due to squeezing.

Preferably, before stitching, the first fluffy flexible thread is placed to be flush with the height of the first inner side and the second inner side, such that the exposed support yarns which are accommodated in the first fluffy flexible thread would be in the same direction, and the stitched structure can be smooth. When sewing, sew at an appropriate constant rate, preferably at a slower rate.

Preferably, a shrinkage rate of the suture in the stitching step is between 1 and 5%.

As confirmed by relevant experiments, on an area of 30*30 cm^{2,} the number of defects such as punctures, yarn-hooking, and contamination in the product of the first embodiment as provided by the method of sewing three-dimensional fabrics is less than four, and the yarn-hooking resistance meets the requirements of the Taiwanese CNS 12475 standard at level 4 or higher.

The present disclosure further provides a three-dimensional fabric, including: a first three-dimensional fabric, a second three-dimensional fabric, and a first fluffy flexible thread. The first three-dimensional fabric has a first inner side and an outer side opposite to the first inner side, the second three-dimensional fabric has at least one second inner side and a second outer side opposite to the second inner side, and the first inner side and the at least one second inner side being connected and defined as a first stitched structure, thereby the first fluffy flexible thread being embedded in the first stitched structure. The first three-dimensional fabric and the second three-dimensional fabric are stitched by the first inner side and the second inner side. Optionally, the three-dimensional fabric further includes a binding tape, stitching on the first outer side and/or second outer side, and forming a binding structure wrapping the second fluffy flexible thread in the binding structure.

The three-dimensional fabric products of the present disclosure can be various products that need to be sewn, stitched, and spliced. For ease of understanding, the second embodiment of the present disclosure provides a three-dimensional fabric product with a bra cup structure, but the present disclosure is not limited thereto. For example, a first bra cup portion 1 and a second bra cup portion 2 described as follows can be used to exemplify the first three-dimensional fabric and the second three-dimensional fabric.

### Second Embodiment

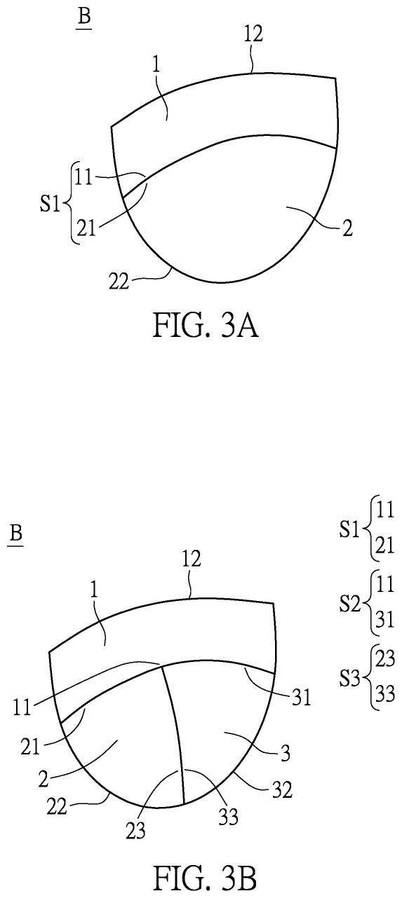

Referring to FIG. 3A to 3B, the second embodiment of the present disclosure provides a bra cup structure B, which can be made of the above-mentioned sewing method for three-dimensional fabrics. As shown in FIG. 3A, the bra cup structure B includes a first bra cup portion 1 and a second bra cup portion 2, the first bra cup portion 1 has a first inner side 11 and a first outer side 12 opposite to the first inner side 11; the second bra cup portion 2 has at least one second inner side 21 and a second outer side 22 opposite to the second inner side 21. Specifically, the bra cup structure B of the present disclosure forms a curved cup structure used in female bras, and underwear by stitching the first bra cup portion 1 and the second bra cup portion 2. The first inner side 11 is spliced to at least one second inner side 21 and defined as a first stitched structure S1, in which, the first fluffy flexible thread L1 (not shown in the figure) embedded in the first stitched structure S1, the first bra cup portion 1 and the second bra cup portion 2 are stitched by the first inner side 11 and the second inner side 21. In addition, the bra cup structure B further includes at least one binding tape stitched on the first outer side 12 and/or second outer side 2, to form a binding structure Similarly, the bra cup structure B further includes a second fluffy flexible thread L2 (not shown in the figure) embedded in the binding structure.

As shown in FIG. 3B, in order to meet design requirements, the bra cup structure B of the present disclosure further includes a third bra cup portion 3. In detail, as shown in FIG. 3B, the bra cup structure B is constituted of a first bra cup portion 1, a second bra cup portion 2 and a third bra cup portion 3. The first bra cup portion 1 has a first inner side 11 and a first outer side 12 opposite to the first inner side 11, the second bra cup portion 2 has three sides, which are two second inner sides 21, 23 and a second outer side 22, and the third bra cup portion 3 has three sides, which are two third inner sides 31, 33, and a third outer side 32. A part of the first inner side 11 and the second inner side 21 are stitched and defined as a first stitched structure S1, the other part of the first inner side 11 is stitched to a part of the third inner side 31 and defined as a second stitched structure S2, the second inner side 23 and the third inner side 33 are spliced and defined as a third stitched structure S3.

Moreover, as shown in FIG. 3B, the bra cup structure B further includes a third fluffy flexible thread L3 and a fourth fluffy flexible thread L4 (not shown in the figure), in which, the third fluffy flexible thread L3 is embedded in the second stitched structure S2, and the fourth fluffy flexible thread L4 is embedded in the third stitched structure S3, through the cooperation of the first bra cup portion 1, the second bra cup portion 2 and the third bra cup portion 3, various curve and radian of bra cup structures can be obtained.

Preferably, the first bra cup portion 1, the second bra cup portion 2 and the third bra cup portion 3 are all multiple-layered fabric as the three-dimensional fabric, which includes the top layer, the bottom layer and an at least one support yarn connecting the top layer and the bottom layer, and the support yarns can be selected from the monofilament support yarns or the multifilament support yarns.

Therefore, the effects of the present disclosure reside in that the technical features of “the first fluffy flexible thread and the three-dimensional fabric” and “a diameter of the first fluffy flexible thread is 0.2 cm more than a thickness of the first three-dimensional fabric or the second three-dimensional fabric” of the present disclosure overcomes the disadvantages of the support yarns being exposed.

Furthermore, the method of sewing the three-dimensional fabric of the present disclosure, reside in that the technical features of “placing a first fluffy flexible thread between the first inner side and the second inner side” and “a diameter of the first fluffy flexible thread is 0.2 cm more than a thickness of the first three-dimensional fabric or the second three-dimensional fabric”, provides a space to accommodate the support yarns which protrudes from the three-dimensional fabrics due to the pressure from sewing. Thereby, the sewing method allows the three-dimensional fabric to be applied to different fabric products, such as clothes, underwear, mattress, fitted sheets, etc.

Further, the three-dimensional fabric sewing method of the present disclosure provides a simple manufacturing process and effectively reducing the use of fabric, in detail, one bolt of fabric can be used to make approximately 3 or 4 times more products than the conventional method, and the three-dimensional fabric sewing method also provides a better way to make curved products (such as bra cups) than a compression molding method. Moreover, on an area of 30*30 cm^{2,} the number of defects such as punctures, yarn-hooking, and contamination in the product of the first embodiment as provided by the method of sewing three-dimensional fabrics is less than four, and the hook yarn resistance meets the requirements of the Taiwanese CNS 12475 standard at level 4 or higher. Thereby, the three-dimensional fabric has a comfortable feel and touch, which meets the needs of clothing products, and is capable of being applied in the manufacturing of female underwear with high comfort requirements.

The three-dimensional fabric structure of the present disclosure overcomes the disadvantages of the support yarns being exposed, which solves the problem of the stitched surface being uneven after sewing, maintains the skin-friendliness and comfort of the product. Moreover, the present disclosure can effectively omit the seam stripe on the stitched structure or the edge, such as to avoid increasing a thickness of the fabric structure, and further provides the advantage of smoothness and being without any visible seams, making them nearly invisible under tight fitting clothing.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method of sewing three-dimensional fabric, comprising:
providing a first three-dimensional fabric and a second three-dimensional fabric, the first three-dimensional fabric having a first inner side, and the second three-dimensional fabric having a second inner side;
placing a first fluffy flexible thread between the first inner side and the second inner side; and
stitching the first inner side and the second inner side to form a stitched structure enveloping the first fluffy flexible thread;
wherein a diameter of the first fluffy flexible thread is 0.2 cm more than a thickness of the first three-dimensional fabric or the second three-dimensional fabric.

2. The method of sewing three-dimensional fabric according to claim 1, wherein a stitch length of the first inner side of first three-dimensional fabric and the second inner side of the second three-dimensional fabric is between 16 and 20 stitches/inch.

3. The method of sewing three-dimensional fabric according to claim 1, wherein each of the first three-dimensional fabric and the second three-dimensional fabric includes: a top layer, a bottom layer and at least one support yarn connecting the top layer and the bottom layer.

4. The method of sewing three-dimensional fabric according to claim 1, wherein a shrinkage rate of the suture in the step of stitching the first inner side and the second inner side is between 1 and 5%.

5. The method of sewing three-dimensional fabric according to claim 1, further including: providing a seam stripe on the stitched structure, and a thickness of the seam stripe is between 0.2 and 0.3 cm.

6. The method of sewing three-dimensional fabric according to claim 1, further including: binding a first outer side of the first three-dimensional fabric and/or a second outer side of the second three-dimensional fabric.

7. The method of sewing three-dimensional fabric according to claim 6, the step of binding further including:
providing a second fluffy flexible thread on a first outer side of the first three-dimensional fabric and/or a second outer side of the second three-dimensional fabric, and covering the second fluffy flexible thread with a binding tape; and
stitching the binding tape, and forming a binding structure enveloping the second fluffy flexible thread on the first outer side and/or the second outer side.

8. A three-dimensional fabric, comprising:
a first three-dimensional fabric including a first inner side and a first outer side opposite to the first inner side;
a second three-dimensional fabric including at least one second inner side and a second outer side opposite to the second inner side, wherein the first inner side and the at least one second inner side are connected and defined as first stitched structure; and
a first fluffy flexible thread embedded in the first stitched structure;
wherein the first three-dimensional fabric and the second three-dimensional fabric are stitched by the first inner side and the second inner side.

9. The three-dimensional fabric according to claim 8, wherein a diameter of the first fluffy flexible thread is 0.2 cm more than a thickness of the first three-dimensional fabric or the second three-dimensional fabric.

10. The three-dimensional fabric according to claim 8, wherein a stitch length of the first inner side of first three-dimensional fabric and the second inner side of the second three-dimensional fabric is between 16 and 20 stitches/inch.
